(19) United States
(12) Patent Application Publication
(10) Pub. No.: US 2003/0234978 A1
(43) Pub. Date: Dec. 25, 2003

(54) Optical waveguide amplifiers

(76) Inventors: Anthony F. Garito, Radnor, PA (US); Renyuan Gao, Wayne, PA (US); Yu-Ling Hsiao, Collegeville, PA (US); Brian Thomas, Exton, PA (US); Jingsong Zhu, Phoenixville, PA (US); Kazuya Takayama, Phoenixville, PA (US)

Correspondence Address: Finnegan, Henderson, Farabow,, Garrett & Dunner, L.L.P., 1300 I Street, N.W., Washington, DC, 20005-3315, US

(21) Appl. No.: 10/338,005

(22) Filed: Jan. 8, 2003

Related U.S. Application Data
(60) Provisional application No. 60/346,748, filed on Jan. 8, 2002.

(51) Int. Cl. H01S 3/00

(52) U.S. Cl. 359/341.5

(57) ABSTRACT

The present invention relates to optical waveguide devices and optical waveguide amplifiers for amplification in a range from 1.5 μm to about 1.6 μm wavelength. The present invention also relates to planar optical waveguides, fiber waveguides, and communications systems employing them. The optical waveguide devices according to the present invention comprise a polymer host matrix. Within the polymer host matrix, a plurality of nanoparticles can be incorporated to form a polymer nanocomposite. To obtain amplification in the above-described range, the nanoparticles comprises Erbium. The host matrix itself may comprise composite materials, such as polymer nanocomposites, and further the nanoparticles themselves may comprise composite materials.

### CROSS-REFERENCE TO RELATED APPLICATION

This application claims the benefit of priory under 35 U.S.C. § 119(e) to U.S. Provisional Application 60/346,748 filed Jan. 8, 2002.

### FIELD OF THE INVENTION

The present invention relates to optical waveguide devices, particularly to optical waveguide devices comprising composite materials, such as polymer nanocomposites. The polymer nanocomposites according to the present invention comprise a polymer host matrix and a plurality of nanoparticles acting as guest materials within the host matrix. The present invention also relates to optical waveguide amplifiers ranging from about 1.5 μm to about 1.6 μm wavelength amplification.

### BACKGROUND

The advent of optical amplifiers and dense wavelength division multiplexing has revolutionized the telecommunications industry by replacing electronic data regenerators between optical fiber transmission links with less expensive, data format “transparent”, optical amplification devices. For example, silica based (Er)-doped fiber amplifiers (EDFA), operating in the range from about 1.5 μm to about 1.6 μm wavelength window, are highly efficient and cost-effective. These Er-doped fiber amplifiers have been the predominant optical amplification devices in long haul terrestrial, and transoceanic networks.

Because of the tremendous success of the EDFA's, most of the long haul, ultra-long haul, and transoceanic networks use signal wavelength channels operating in the Erbium (Er) amplification window ranging from about 1.5 μm to about 1.6 μm.

As the demand for increased bandwidth and broad-ban gain continues to sore, there exist an enormous need for optimizing components operating in the 1.5 μm to about 1.6 μm telecommunication window. There is also a need to find new Er containing materials with and intrinsically wide, and flat gain spectra.

Several different types of technologies have been attempted and evaluated in the past several years, including semiconductor optical amplifiers, Raman fiber amplifiers, and fiber amplifiers doped with rare-earth elements. Because of various performance and manufacturing problems, such as low efficiency, high noise, poor reliability, etc, none of the above mentioned technologies have been widely used in optical networks. For example, Er³⁺ containing two-phase transparent glass-ceramics have been used for gain-flattening, but the extra heat-treatment steps necessary in fabrication, as well as the increased up-conversion associated with these materials have made them problematic. Other materials used, such as fluoride glass fibers, have additional shortcomings including poor durability, glass instability, problems with up-conversion, and spicing issues. Consequently, there is a need for components employing materials with greater Er³⁺ solubility that are shorter, more compact, more durable, and offer greater gain in the L-band of Er^{3+.}

Among the various approaches for 1.5 μm to about 1.6 μm amplification, Er doped fiber amplifiers have received the most attention. Er doped amplifiers have been the most promising because of their higher efficiency. Most of the reported prior art 1.5 μm to about 1.6 μm Er-doped amplifiers, however, employ fluoride, halide, chalcogenide, chalcohalide, selenide, and arsenic glasses.

These glasses are fabricated into optical fiber performs, and drawn into amplification optical fibers. Alternatively, planar waveguides can be formed using a doped fluoride glass substrate. In either case, the prior art technology relies on fluoride, halide, chalcogenide, chalcohalide, selenide, and arsenic glasses. These glasses are extremely mechanically fragile and sometimes moisture sensitive, thus making device reliability a severe issue. Another problem with glasses is that only low levels of dopant are possible thus; longer lengths of fiber are require to obtain a sufficient level of gain.

Impurities in the glass materials, as well as the presence of hydrogen and oxygen, result in absorption losses. Additionally, there are attenuation maxima associated with small-band wavelength regions. These fundamental attenuated wavelength regions of highest absorption correspond to the presence of ions like (OH⁻). For example, it is well known that quartz has one such region of highest absorption at 2.7 μm. Other similar absorption bans occur at 1.38 μm, 1.24 μm, 0.95 μm, and 0.72 μm.

Between these wavelength bands of absorption there are “windows” of minimal attenuation. It is commonly known in the art that the first window occurs at 0.85 μm, the second at 1.3 μm, and the third at 1.5 μm. Since these regions are used for data transmission and communication technology, host matrix materials tending to degrade and reduce the strength of light signals passed through the composite materials are problematic.

Likewise, typical hydrocarbon polymers commonly exhibit high absorption losses that can degrade their optical properties. These absorptions also originate from overtones of fundamental molecular vibrations within the hydrocarbon polymers. Many of these absorptions overtones fall within the range of wavelengths prevalent in telecommunications applications. For example, the highly absorptive overtones associated with C—H bonds of typical hydrocarbon polymers fall within the range of wavelengths used in telecommunications applications. These absorptive overtones cause the matrix materials, such as hydrocarbon polymers, to degrade and reduce the strength of light signals passed through composite materials containing such matrix materials.

Devices based on discrete fiber components such as Er-doped fluoride fibers are difficult, time consuming, and costly to build into amplifier device modules. The complexities arise from the numerous splices required for connecting various components in the module, such as, for example, the pump/signal coupler, and tap coupler.

It is well known by those skilled in the art that planar waveguides provide a platform for achieving optical component integration. Planar waveguide based optical amplifiers have been developed in silica based glass containing rare-earth elements, primarily for 1.55 μm wavelength amplification. The optical gain medium can be formed by various processes, such as, for example, chemical vapor deposition, ion exchange, photolithography, flame-hydrolysis, and reactive ion-etching. The resulting gain medium can take the form of a straight line or curved rare-earth doped waveguide. Pump lasers with various wavelengths pump such rare-earth doped waveguide. The pump lasers are combined with the signal, for example from about 1.5 μm to about 1.6 μm for Er-doped channel waveguide, by a directional coupler. Optical isolators are inserted into the optical path to prevent back-reflected signal amplification in the rare-earth doped channel waveguides.

An optical amplifier amplifies optical signal directly in the optical domain without converting the signal into an electrical signal. The key to an optical signal amplifier device is the gain medium. Generally, materials for EDFA's designed for large-bandwidth applications should offer a flat gain spectrum spanning the wavelength range from about 1.53 μm to about 1.61 μm.

A gain medium can be made by doping the core of an optical fiber with rare-earth ions. A rare-earth doped optical fiber, however, has the disadvantage of high-cost, long length, and difficulty of integration with other optical components, such as optical couplers, splitters, detectors, and diode lasers, resulting in high cost of manufacturing and bulkiness of the devices. Thus, it would be beneficial to have an integrated solution for optical amplification.

The use of rare-earth doped glass waveguides is well known in the art. In order to form glass channel waveguides, however, it is necessary to form glass films for the under-cladding, core, and over-cladding layers. Typical fabrication processes of glass films include, chemical vapor deposition, plasma enhanced chemical vapor deposition, and flame hydrolysis. These fabrication processes require complex equipment, are time consuming, and costly. Moreover, these processes have been developed only for silica-based glass, which is only compatible with Er-doped amplifiers operating in the 1.55 μm wavelength window.

Composite materials are well known, and generally comprise two or more materials each offering its own set of properties or characteristics. The two or more materials may be joined together to form a system that exhibits properties derived from each of the materials. A common form of a composite is one with a body of a first material acting as a host matrix with a second guest material distributed in the matrix.

One class of composite materials includes guest nanoparticles distributed within the host matrix material. Nanoparticles are particles of a given material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range. For example, particles having the smallest dimension as small as about 1 nm and as large as about 1×10³ nm could still be considered nanoparticles. Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements.

Composite materials including nanoparticles distributed within a host matrix material have been used in optical applications. For example, U.S. Pat. No. 5,777,433 (the '433 patent) discloses a light emitting diode (LED) that includes a packaging material including a plurality of nanoparticles distributed within a host matrix material. The nanoparticles increase the index of refraction of the host matrix material to create a packaging material that is more compatible with the relatively high refractive index of the LED chip disposed within the packaging material. Because the nanoparticles do not interact with light passing through the packaging material, the packaging material remains substantially transparent to the light emitted from the LED.

While the packaging material used in the '433 patent offers some advantages derived from the nanoparticles distributed within the host matrix material, the composite material of the '433 patent remains problematic. For example, the composite material of the '433 patent includes glass or ordinary hydrocarbon polymers, such as epoxy and plastics, as the host matrix material. While these materials may be suitable in certain applications, they limit the capabilities of the composite material in many other areas. For example, the host matrix materials of the '433 patent commonly exhibit high absorption losses.

Additionally, the method of the '433 patent for dealing with agglomeration of the nanoparticles within the host matrix material is inadequate for many composite material systems. Agglomeration is a significant problem when making composite materials that include nanoparticles distributed within a host matrix material. Because of the small size and great numbers of nanoparticles that may be distributed within a host matrix material, there is a large amount of interfacial surface area between the surfaces of the nanoparticles and the surrounding host matrix material. As a result, the nanoparticle/host-matrix material system attempts to minimize this interfacial surface area, and corresponding surface energy, by combining the nanoparticles together to form larger particles. This process is known as agglomeration. Once the nanoparticles have agglomerated within a host matrix material, it is extremely difficult to separate the agglomerated particles back into individual nanoparticles.

Agglomeration of the nanoparticles within the host matrix material may result in a composite material that lacks a desired characteristic. Specifically, when nanoparticles agglomerate together, the larger particles formed may not behave in a similar way to the smaller nanoparticles. For example, while nanoparticles may be small enough to avoid scattering light within the composite material, agglomerated particles may be sufficiently large to cause scattering. As a result, a host matrix material may become substantially less transparent in the presence of such agglomerated particles.

To combat agglomeration, the composite material of the '433 patent includes an anti-flocculant coating disposed on the nanoparticles intended to inhibit agglomeration. Specifically, the '433 patent suggests using surfactant organic coatings to suppress agglomeration. These types of coatings, however, may be inadequate or ineffective especially when used with host matrix materials other than typical hydrocarbon polymers.

As a result, there is a need in the art for an easy to manufacture, integrated about 1.5 μm to about 1.6 μm wavelength optical amplifiers, as well as optical amplifiers that overcome one or more of the above-described problems or disadvantages of the prior art. It is also desirable to have a waveguide amplifier material system, and fabrication process, that is versatile, reliable, and cost-effective. Additionally, modern telecommunication networks increasingly need compact, low cost, and integrated optical signal regeneration and amplification devices.

### SUMMARY OF THE INVENTION

The present invention relates to optical waveguide devices and optical waveguide amplifiers for amplification in a range from about 1.5 μm to about 1.6 μm wavelength. The present invention also relates to planar optical waveguides, fiber waveguides, and communications systems employing them. The optical waveguide devices according to the present invention comprise a host matrix based on polymers. Within the host matrix, a plurality of nanoparticles can be incorporated as guest materials to form a nanocomposite. In fact, the host matrix itself may comprise composite materials, such as polymer nanocomposites, and further the nanoparticles themselves may comprise composite materials.

The nanocomposites according to the present invention comprise a host matrix and a plurality of nanoparticles within the host matrix.

In one embodiment of the present invention, the optical planar waveguide operating in the third window of minimal absorption comprises a nanoparticle polymer composite. In yet another embodiment, the amplifiers according to the present invention employ Er-doped polymer nano-composite for broadband 1.5 μm wavelength amplification.

In another embodiment of the present invention, there is a process of forming an optical waveguide comprising a composite material, which includes a host matrix and a plurality of nanoparticles within the host matrix. In such embodiments, the plurality of nanoparticles may comprise at least one rare-earth containing material such as Er.

In yet another exemplary embodiment according to the present invention, there is an optical waveguide amplifier comprising a composite material, which includes a halogen containing host matrix, and a plurality of nanoparticles within the host matrix. In such embodiments, the plurality of nanoparticles comprises at least one dopant material that provides amplification at wavelengths ranging from about 1.5 μm to about 1.6 μm, further from 1.57 μm to about 1.62 μm,

An example of an optical amplifying waveguide according to the present invention includes a core comprising a composite material, which includes a host matrix, and a plurality of nanoparticles dispersed within the host matrix. A majority of the plurality of nanoparticles may be bare or include a halogenated outer coating layer. Advantageously, the nanoparticles comprise at least one Er containing material. In certain embodiments, the optical amplifying waveguide may include a core-cladding comprised of a lower refractive index material, such that a core-cladding refractive index difference is small enough to result in a single optical mode propagation for optical wavelengths ranging from 1.5 μm to about 1.6 μm.

Another example of the present invention is an apparatus for optical communication including: an active material comprising, a halogen containing host matrix, and a plurality of nanoparticles within the host matrix. The plurality of nanoparticles may comprise at least one material chosen from rare-earth elements, such as Er. Such an apparatus generates an optical signal and an optical pumping, provides the optical signal and the optical pumping to the waveguide; and controls light emitted from the optical waveguide.

A further example includes an optical amplifier for wavelength ranging from about 1.5 μm to about 1.6 μm. The amplifier again may comprise a nanoparticle composite material comprising a host matrix and a plurality of nanoparticles dispersed within the host matrix. A majority of nanoparticles which include at least one material chosen rare-earth elements, such as Er; may be bare or contain a halogenated outer coating layer.

The present invention also encompasses a method for amplifying a light signal. For example a method for amplifying a light signal can include forming a component from a composite material comprising a halogen containing host matrix, and a plurality of nanoparticles within the host matrix. The nanoparticles suitably comprise at least one material chosen rare-earth elements, such as Er. The method next involves exciting ions of the at least one material into their excited energy state. The pump photons enter the doped fiber or waveguide core (doped with at least one material chosen from rare-earth elements such as Er), and are absorbed by the ground state Er ions. The absorption of the pump photons causes the excitation of the ions into their excited energy state. The excited state ions rapidly (in less than about 10 μsec) relax to the metastable excited state. The metastable excited state has a relatively long lifetime when not triggered (greater than about 1 msec). When triggered by a signal photon with wavelength around 1.5 μm, the metastable state ion drops back to its ground state and emits a photon substantially identical to the triggering signal photon, thereby amplifying the signal.

Another method according to the present invention includes amplifying a light signal. This method comprises forming a component from a composite material, which includes a halogen containing host matrix, and a plurality of nanoparticles within the halogen containing host matrix. The nanoparticles according to this method comprise at least one material capable of producing stimulated emissions of light of wavelength ranging from about 1.5 μm to about 1.6 μm.

In yet another embodiment of the present invention, there is an optical waveguide comprising a core for transmitting incident light, and a cladding material disposed about the core. The core of the optical waveguide may comprise a host matrix, and a plurality of nanoparticles dispersed within the host matrix, where the plurality of nanoparticles includes a halogenated outer coating layer.

A general description of methods for fabricating polymer optical waveguides and polymer optical waveguide amplifiers based on polymer film formation and subsequent channel formation processes can be found in related co-pending application number Ser. No. 10/243,833, the contents of which are herein incorporated by reference.

In one embodiment, the inventive amplifier comprises perfluorinated polymer waveguide host matrix materials. In such an embodiment, the perfluorinated polymer waveguide core may comprise nanometer size particles of various glasses, polymers, and crystal materials. The nanometer size particles are doped with at least Er for about 1.5 μm to about 1.6 μm amplification. In other embodiments, the particles may further be co-doped with other rare-earth elements, such as Yb. The nanoparticles may be evenly and randomly distributed within the waveguide core and do not significantly change the processing conditions of the waveguide formation. Furthermore, as the host matrix polymer material serves as a hermetic seal and mechanical support for the nanoparticles, there is a large group of nanoparticles that can be used with the host matrix core material without the concern of processability, reliability, and environmental stability. For example, some crystal materials doped with at least one Er containing material can be utilized to form nano-composite polymer optical waveguides that are not previously possible in their pure and bulk form.

### BRIEF DESCRIPTION OF THE DRAWINGS

In the drawings:

FIG. 1 depicts a schematic representation of an exemplary composite material according to one embodiment of the invention.

FIG. 2 depicts a schematic cross-sectional view of a waveguide according to another embodiment of the present invention.

FIG. 3 depicts a schematic representation of a curved waveguide according to another exemplary embodiment of the present invention.

FIG. 4 depicts a schematic representation of waveguides showing one embodiment according to the present invention.

FIG. 5 depicts a schematic representation of another waveguide embodiment of the present invention.

FIG. 6 depicts schematic representation of a composite material comprising nanoparticles according to another embodiment of the present invention.

FIG. 7 depicts a schematic representation of nanoparticles according to another embodiment of the present invention.

FIG. 8 depicts a flowchart showing one representation of a process for forming a composite material according to one embodiment of the present invention.

FIG. 9 depicts the energy level diagrams for an Er ion

FIG. 10 depicts an optical amplifier in a communication/transmission system according to one embodiment of the present invention.

FIG. 11 illustrates typical emission and absorption cross-section spectra of nanoparticles composed of Er-doped phosphate glass and alumino-germano-silicate glasses.

FIG. 12 illustrates typical absorption cross-section of Yb as compared with the absorption cross-section of Er.

FIG. 13 shows 1.55 μm single channel small signal gain evolution in a polymer nanocomposite, Er-doped waveguide, with particles composed of Er-doped phosphate glass, or alumino-germano-silicate glass with parameters listed in Table 1.

FIG. 14 shows the gain dependence on input signal power levels for an Er-doped alumino-germano-silicate glass/polymer nanocomposite waveguide amplifier. The parameters for this waveguide amplifier are listed in Table 1.

FIG. 15 shows the gain spectra of a 10 centimeter long phosphate glass and alumino-germano-silicate glass/polymer nanocomposite waveguide amplifier.

FIG. 16 shows the gain spectra of a 30 centimeter long phosphate glass and alumino-germano-silicate glass/polymer nanocomposite waveguide amplifier.

FIG. 17 shows the gain spectra of a 50 centimeter long phosphate glass and alumino-germano-silicate glass/polymer nanocomposite waveguide amplifier.

### DETAILED DESCRIPTION OF THE INVENTION

In the following description, reference is made to the accompanying drawings that form a part thereof, and in which is shown by way of illustration specific exemplary embodiments in which the invention can be practiced. These embodiments are described in sufficient detail to enable those skilled in the art to practice the invention, and it is to be understood that other embodiments can be utilized and that changes can be made without departing from the scope of the present invention.

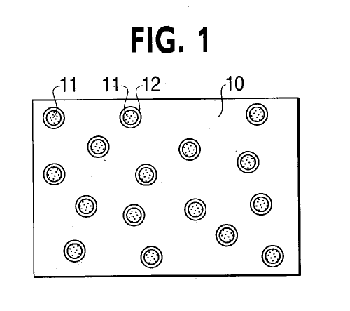

FIG. 1 provides a diagrammatic representation of a composite material according to an embodiment of the invention. In one embodiment, the nano-composite waveguide core comprises the composite material. The composite material includes host matrix 10 and plurality of nanoparticles 11 dispersed either uniformly or non-uniformly within the host matrix 10. The plurality of nanoparticles 11 may include halogenated outer coating layer 12, which at least partially coats nanoparticles 11 and discourages their agglomeration. The nanoparticles 11 according to the present invention may be doped with at least one Er-doped material. The nanoparticles of doped glassy media, single crystal, or polymer are embedded in the host matrix core material 10. The distributions of the active nanoparticles are random and homogenous. The nano-particles of Er and/or Yb doped glasses, single crystals, or polymers are embedded in the polymer core material. In cases where there is interface delamination due to mismatches of mechanical, chemical, or thermal properties between the nanoparticles and the surrounding polymer core host matrix, a compliance layer may be coated on the nanoparticles to enhance the interface properties between the nanoparticles and the host matrix polymer core material.

As shown in FIG. 1, the nanoparticles may include an outer layer 12. As used herein, the term layer is a relatively thin coating on the outer surface of an inner core (or another inner layer) that is sufficient to impart different characteristics to the outer surface. The layer need not be continuous or thick to be an effective layer, although it may be both continuous and thick in certain embodiments.

The host matrix 10 can comprise a halogenated elastomer, a perhalogenated elastomer, a halogenated plastic, or a perhalogenated plastic, either by itself or in a blend with other matrix material listed herein.

In another embodiment, the host matrix 10 may comprise a polymer, a copolymer, or a terpolymer having at least one halogenated monomer represented by one of the following formulas:

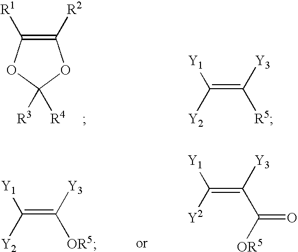

wherein R¹, R², R³, R⁴, and R⁵, which may be identical or different, are each chosen from linear or branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane. Y₁ and Y₂, which may be identical or different, are each chosen from H, F, Cl, and Br atoms. Y₃ is chosen from H, F, Cl, and Br atoms, CF₃, and CH₃.

Alternatively, the polymer may comprise a condensation product made from the monomers listed below:

HO—R—OH+NCO—R′—NCO; or

HO—R—OH+Ary¹-Ary²,

wherein R, R′, which may be identical or different, are each chosen from halogenated alkylene, halogenated siloxane, halogenated ether, halogenated silylene, halogenated arylene, halogenated polyether, and halogenated cyclic alkylene. Ary¹, Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the host matrix 10 can comprise a halogenated cyclic olefin polymer, a halogenated cyclic olefin copolymer, a halogenated polycyclic polymer, a halogenated polyimide, a halogenated polyether ether ketone, a halogenated epoxy resin, a halogenated polysulfone, or halogenated polycarbonate.

The host matrix 10, for example, the fluorinated polymer host matrix 10, may exhibit very little absorption loss over a wide wavelength range. Therefore, such fluorinated polymer materials may be suitable for optical applications.

In one embodiment, the halogenated aryl, alkyl, alkylene, alkylene ether, alkoxy, siloxane, ether, polyether, thioether, silylene, and silazane groups are at least partially halogenated, meaning that at least one hydrogen in the group has been replaced by a halogen. In another embodiment, at least on hydrogen in the group may be replaced by fluorine. Alternatively, these aryl, alkyl, alkylene, alkylene ether, alkoxy, siloxane, ether, polyether, thioether, silylene, and silazane groups may be completely halogenated, meaning that each hydrogen of the group has been replaced by a halogen. In an exemplary embodiment, the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may include between 1 and 12 carbon atoms.

Additionally, host matrix 10 may comprise a combination of one or more different halogenated polymers, such as fluoropolymers, blended together. Further, host matrix 10 may also include other polymers, such as halogenated polymers containing functional groups such as phosphinates, phosphates, carboxylates, silanes, siloxanes, sulfides, including POOH, POSH, PSSH, OH, SO₃H, SO₃R, SO₄R, COOH, NH₂, NHR, NR₂, CONH₂, NH—NH2, and others, where R may comprise any of aryl, alkyl, alkylene, siloxane, silane, ether, polyether, thioether, silylene, and silazane. Further, host matrix 10 may also include homopolymers or copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. Further, the host matrix may also include a hydrogen-containing fluoroelastomer, a hydrogen-containing perfluoroelastomer, a hydrogen containing fluoroplastic, a perfluorothermoplastic, at least two different fluoropolymers, or a cross-linked halogenated polymer.

Examples of the host matrix 10 include: poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2 ,2,4-trifluoro-5-trifluoromethoxy-1 ,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, fluorinated Nafion®, and fluorinated poly(phenylenevinylene). The host matrix 10 may further include inactive fillers, for example silica.

Additionally, the host matrix may comprise any polymer sufficiently clear for optical applications. Examples of such polymers include polymethylmethacrylates, polystyrenes, polycarbonates, polyimides, epoxy resins, cyclic olefin copolymers, cyclic olefin polymers, acrylate polymers, PET, polyphenylene vinylene, polyether ether ketone; poly (N-vinylcarbazole), acrylonitrile-styrene copolymer, Nafionn®, poly(phenylenevinylene), polyfluoroacrylates, fluorinated polycarbonates, perfluoro-polycyclic polymers, fluorinated cyclic olefins, or fluorinated copolymers of cyclic olefins.

By including halogens, such as fluorine, into host matrix 10, the optical properties of host matrix 10 and the resulting composite material are improved over conventional composite materials. Unlike the C—H bonds of hydrocarbon polymers, carbon-to-halogen bonds (such as C—F) shift the vibrational overtones toward longer wavelengths out of the ranges used in telecommunication applications. Specifically, the carbon-to-halogen bonds exhibit vibrational overtones having low absorption levels ranging from about 0.8 μm to about 0.9 μm, and ranging from about 1.2 μm to 1.7 μm. As hydrogen is removed through partial to total halogenation, the absorption of light by vibrational overtones is reduced. One parameter that quantifies the amount of hydrogen in a polymer is the molecular weight per hydrogen for a particular monomeric unit. For highly halogenated polymers useful in optical applications, this ratio may be 100 or greater. This ratio approaches infinity for perhalogenated materials.

Nanoparticles 11 may comprise various different materials, and they may be fabricated using several different methods. In one embodiment of the invention, the nanoparticles are produced using an electro-spray process. In this process, very small droplets of a solution including the nanoparticle precursor material emerge from the end of a capillary tube, the end of which is maintained at a high positive or negative potential. The large potential and small radius of curvature at the end of the capillary tube creates a strong electric field causing the emerging liquid to leave the end of the capillary as a mist of fine droplets. A carrier gas captures the fine droplets, which are then passed into an evaporation chamber. In this chamber, the liquid in the droplets evaporates and the droplets rapidly decrease in size. When the liquid is entirely evaporated, an aerosol of nanoparticles is formed. These particles may be collected to form a powder or they may be put into a solution. The size of the nanoparticles is variable and depends on processing parameters.

In an exemplary embodiment of the present invention, nanoparticles 11 have a major dimension of less than about 50 nm. That is, the largest dimension of the nanoparticle (for example the diameter in the case of a spherically shaped particle) is less than about 50 nm.

Other processes are also useful for making the nanoparticles 11 of the present invention. For example, the nanoparticles may be fabricated by laser ablation, laser-driven reactions, flame and plasma processing, solution-phase synthesis, sol-gel processing, spray pyrolysis, flame pyrolysis, laser pyrolysis, flame hydrolysis, mechanochemical processing, sono-electro chemistry, physical vapor deposition, chemical vapor deposition, mix-alloy processing, decomposition-precipitation, liquid phase precipitation, high-energy ball milling, hydrothermal methods, glycothermal methods, vacuum deposition, polymer template processes, micro emulsion processes or any other suitable method for obtaining particles having appropriate dimensions and characteristics.

Several classes of materials may be used to form nanoparticles 11 depending upon the effect the nanoparticles are to have on the properties of the composite containing them. In one embodiment, nanoparticles 11 may include one or more active materials, which allow the composite to be a gain medium. Active materials amplify a light signal as the light signal encounters the active material. Active materials include rare-earth containing compounds or ions, and chromium compounds or chromium ions. Rare-earth as used herein is understood to include Yttrium and Scandium. Active materials also include V²⁺, V³⁺, Cr³⁺, Cr⁴⁺, Co²⁺, Fe²⁺, Ni²⁺, Ti³, and Bi³⁺.

Due to the relatively lack of parasitic second order optical processes and the ease of doping into various hosts, most Er doped systems have relatively high efficiencies in the range of 50-100%. The most widely used Er dope aluminosilicate glass and phosphate glass have efficiencies of 80-100%.

In certain embodiments, Er alone or together with other rare-earth elements may be incorporated in a nanoparticle for amplification ranging from about 1.5 μm to about 1.6 μm, further about 1.57 μm to about 1.62 μm.

In certain embodiments, Er and Yb alone or together may be incorporated in a nanoparticle for amplification ranging from about 1.5 μm to about 1.6 μm, further from about 1.57 μm to about 1.62 μm.

In yet further embodiments, Yb alone or together with other rare-earth elements may be incorporated in a nanoparticle for amplification ranging from about 1.5 μm to about 1.6 μm, further from about 1.57 μm to about 1.62 μm.

In another embodiment, Er and Yb alone or together with other rare-earth elements may be incorporated in a nanoparticle for amplification ranging from about 1.5 μm to about 1.6 μm, further from about 1.57 μm to about 1.62 μm.

In certain embodiments, Er and Yb are each alone or together co-doped with other active ions in crystal nanoparticles for amplification ranging from about 1.5 μm to about 1.6 μm, further from about 1.57 μm to about 1.62 μm. In another embodiment, several separate species of nanoparticles containing an active ion such as Er and Yb, and other active ions may be doped into the polymer hosts.

The material that forms the matrix of nanoparticle 11 may be in the form of an ion, alloy, compound, or complex, and may comprise the following: an oxide, phosphate, halophosphate, phosphinate, arsenate, sulfate, borate, aluminate, gallate, silicate, germanate, vanadate, niobate, tantalite, tungstate, molybdate, alkalihalogenate, halogenide, nitride, selenide, sulfide, sulfoselenide, tetrafluoroborate, hexafluorophosphate, phosphinate, and oxysulfide.

Semiconductor compounds may also be used to form nanoparticles 11. These materials include, for example, Si, Ge, SiGe, GaP, GaAs, InP, InAs, InSb, PbSe, PbTe, and other semiconductor materials, as well as their counterparts doped with a rare-earth or transition metal ion.

Metal containing materials such as metal chalocogenides, metal salts, transition metals, transition metal complexes, transition metal containing compounds, transition metal oxides, and organic dyes, such as, for example, Rodamin-B, DCM, Nile red, DR-19, and DR-1, and polymers may be used. ZnS, or PbS doped with a rare-earth or transition metal for optical amplification can also be used to form nanoparticles. Additionally, oxides such as TiO₂ and SiO₂ may also be used.

In one embodiment of an amplifier according to the present invention, the nanoparticles are coated with a polymer, such as a halogenated polymer. In certain embodiments, the coated nanoparticles comprise one or more active materials. Coated nanoparticles comprising active materials find particular utility as low phonon energy gain media.

Inclusion of nanoparticles 11 into host matrix material 10, at least in one particular application, may provide a composite material useful in optical waveguide applications. For example, nanoparticles 11 provide the capability of fabricating a waveguide material having a particular index of refraction. By controlling the index of refraction in this way, transmission losses in optical waveguides resulting from index of refraction mismatches in adjacent materials could be minimized. Additionally, because of the small size of nanoparticles 11, the composite material may retain all of the desirable transmission properties of halogenated matrix material 10. Using the nanoparticles disclosed herein, the index of refraction is tuned to from about 1 to about 5.

In optical waveguide applications, the major dimension of the nanoparticles described herein is smaller than the wavelength of light used. Therefore, light impinging upon nanoparticles 11 will not interact with, or scatter from, the nanoparticles. As a result, the presence of nanoparticles 11 dispersed within the host matrix material 10 has little or no effect on light transmitted through the host matrix. Even in the presence of nanoparticles 11, the low absorption loss of host matrix 10 may be maintained.

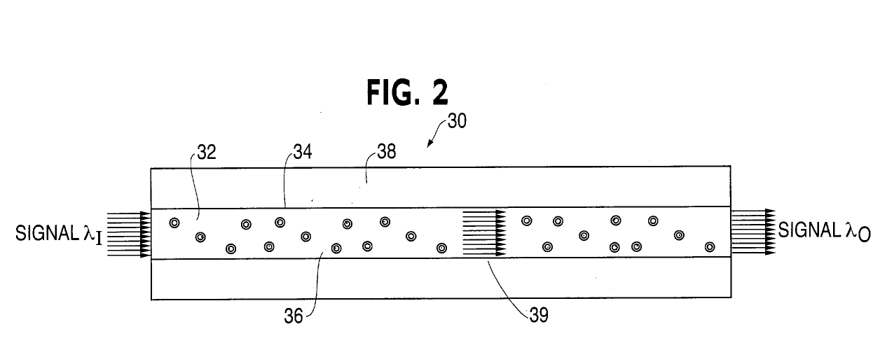

FIG. 2 shows a schematic cross-sectional view of a planar optical waveguide 30 formed using the nanoparticles. A cladding 38 surrounds a core 32 comprised of a host matrix 34 containing the coated nanoparticles 36. In one embodiment, the cladding 38 has a lower index of refraction than core 32. In this embodiment, the nanoparticles added to core 32 increase the index of refraction of the material comprising core 32.

In such an embodiment, input light λ_{I} is injected into the waveguide 30 at one end. The input light λ_{I} is confined within the core 32 as it propagates through core 32. The small size of the nanoparticles allows the input light λ_{I} to propagate without being scattered, which would contribute to optical power loss. Input light λ_{I} interacting with the nanoparticles 36, thus, amplifying the light signal shown schematically at 39.

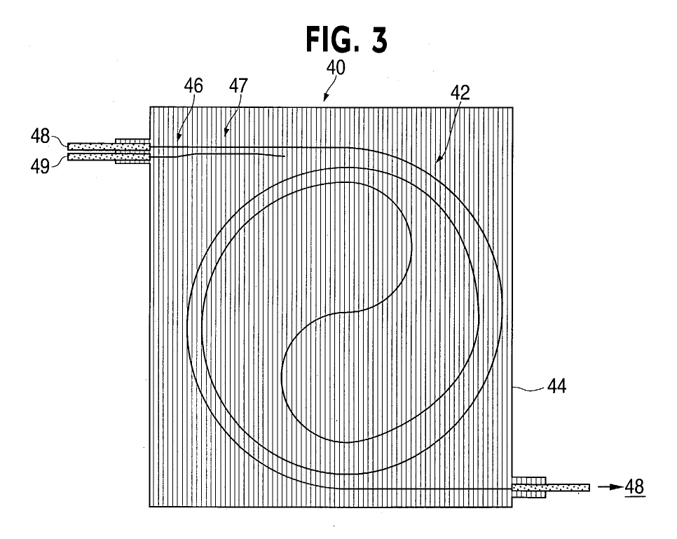

FIG. 3 shows another embodiment of the invention, a curved waveguide amplifier 40 for optical amplification using a core (not shown) comprised of a host matrix containing doped nanoparticles. In this embodiment, the matrix comprises a host matrix material and the coating of the nanoparticles comprises a halogenated polymer material. A curved waveguide 42 on a substrate 44 allows a relatively long amplification waveguide path length in a relatively small area. In certain embodiments, the substrate 44 may comprise a polymer. Those skilled in the art may employ, for example the method of lines, or simple geometric principals when choosing the optimum layout for curved amplifiers according to the present invention.

Another embodiment according to the present invention comprises an optical integrated amplification device.

In another embodiment a direction wavelength divisional multiplexer (WDM) coupler 46 is placed on a waveguide chip 47 to combine a signal light λ_{S} 48 and a pump light λₚ 49. The pump light λₚ 49 stimulates the active material included in the doped nanoparticles in the core to amplify the signal light λₛ 48.

When the nanoparticles in the core comprise one or more of the active materials, a wavelength of the signal light is a broadband signal ranging from about 0.8 μm to about 0.9 μm, and further from about 1.2 μm to about 1.7 μm is amplified. When the nanoparticles in the core comprise at least on material chosen from Er and Yb, a wavelength of the signal light ranging from about 1.5 μm to about 1.6 μm, further from 1.5 μm to about 1.6 μm, and yet further from about 1.57 μm to about 1.61 μm, and further about 1.55 μm is amplified. When the nanoparticles in the core comprise Er, the wavelength of the signal light ranging from about 1.5 μm to about 1.6 μm, from about 1.57 μm to about 1.61 μm, and further about 1.55 μm is amplified. In a further embodiment, the nanoparticles in the core may comprise one or more active materials. The index of refraction of the core and/or cladding may be adjusted to a desired value with the inclusion of nanoparticles.

Generally, the index of refraction of a composite that includes nanoparticles of appropriate compositions can be adjusted to different selected values. For example, adding nanoparticles disclosed herein to the host matrix will tune the refractive index of the composite to be from 1 to about 5. As a result, the nanocomposite material is suitable for use in various optical applications such as waveguides according to the present invention. The index of refraction for the nanoparticles may be determined using techniques known to one of ordinary skill in the art. These techniques include, metricon or elipsometer measurements, and index matching fluids.

As previously stated, halogenated polymers, including fluorinated polymers, exhibit very little absorption loss (see Table 1).

TABLE 1
Wavelengths and intensities of some important vibrational overtones

| Band | n | Wavelength (nm) | Intensity (relative) |
|---|---|---|---|
| C—H | 1 | 3390 | 1 |
| C—H | 2 | 1729 | 7.2 × 10⁻² |
| C—H | 3 | 1176 | 6.8 × 10⁻³ |
| C—F | 5 | 1626 | 6.4 × 10⁻⁶ |
| C—F | 6 | 1361 | 1.9 × 1O⁻⁷ |
| C—F | 7 | 1171 | 6.4 × 10⁻⁹ |
| C═O | 3 | 1836 | 1.2 × 10⁻² |
| C═O | 4 | 1382 | 4.3 × 10⁻⁴ |
| C═O | 5 | 1113 | 1.8 × 10⁻⁵ |
| O—H | 2 | 1438 | 7.2 × 10⁻² |

Therefore, these halogenated polymers may be particularly suitable for transmitting light in optical waveguides and other applications according to the present invention. In such applications, nanoparticles 11 are smaller than the wavelength of incident light. Therefore, light impinging upon nanoparticles 11 will not interact with, or scatter from, the nanoparticles. As a result, the presence of nanoparticles 11 dispersed within the halogenated matrix material 10 has little or no effect on the optical clarity of the composite, even if the nanoparticles themselves comprise material, which in bulk form would not be optically clear, or even translucent. Thus, even in the presence of nanoparticles 11, the low absorption loss of host matrix 10 may be maintained.

By contrast, the presence of nanoparticles 11 within halogenated matrix material 10 may contribute to significantly different properties as compared to the host matrix material alone. For example, as already noted, nanoparticles 11 may be made from various semiconductor materials, which may have index of refraction values ranging from about 1 to about 5. Upon dispersion of nanoparticles 11 into halogenated matrix material 10, the resulting composite material will have an index of refraction value somewhere between the index of refraction of halogenated matrix material 10 (usually less than about 2) and the index of refraction of the nanoparticle material. The resulting, overall index of refraction of the composite material will depend on the concentration and make-up of nanoparticles 11 within halogenated matrix material 10. For example, as the concentration of nanoparticles 11 in halogenated matrix material 10 increases, the overall index of refraction may shift closer to the index of refraction of the nanoparticles 11. The value of n_{comp} can differ from the value of nₘₐₜᵣᵢₓ by a range of about 0.2% to about 330%. In an exemplary embodiment, the ratio of n_{particle}:nₘₐₜᵣᵢₓ is at least 3:2. In another exemplary embodiment, the ratio of n_{particle}:nₘₐₜᵣᵢₓ is at least 2:1.

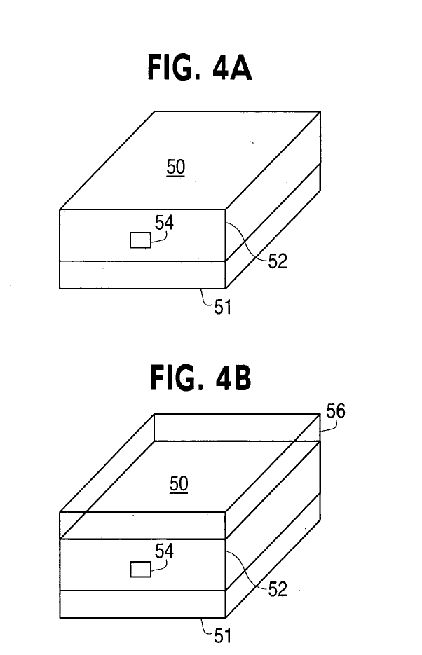

FIG. 4 schematically illustrates an optical waveguide 50 according to one embodiment of the present invention. Optical waveguide 50 includes a generally planar substrate 51, a core material 54 for transmitting incident light and a cladding material 52 disposed on the substrate 51, which surrounds the core 54 and promotes total internal reflection of the incident light within the core material 54. The core 54 of the optical waveguide may be formed of a nanocomposite as illustrated, for example, in FIG. 1.

The cladding 51 and 52 may be each independently composed of an optical polymer, such as a perfluorinated polymer. The waveguide core 54 may be composed of a nano-composite material for example doped glass, single crystal, or polymer particles with dimensions ranging from about 1 nm to about 100 nm are embedded in a polymer waveguide core. The dopant may comprise at least one material chosen from Er and Yb.

In such an embodiment, the core 54 may include a host matrix and a plurality of nanoparticles dispersed within the host matrix. A majority of the plurality of nanoparticles present in core 54 includes a halogenated outer coating layer. The cladding material in this embodiment comprises a host matrix. In certain embodiments, the cladding material may further include nanoparticles dispersed in a host matrix in such a way that the relative properties of the core and cladding can be adjusted to predetermined values.

Further, in one embodiment of the present invention, the host matrix material of the core 54 and/or cladding layer 52 includes fluorine. The nanoparticles in the optical waveguide 50 may have an index of refraction of ranging from about 1 to about 5. By selecting a particular material having a particular index of refraction value, the index of refraction of the core 54 and/or cladding layer 52 of the optical waveguide 50 may be adjusted to a predetermined desired value or to different predetermined values.

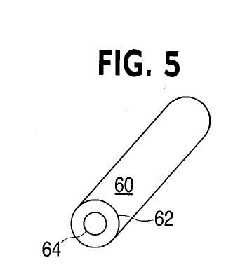

FIG. 5 illustrates an optical waveguide 60 according to another embodiment of the present invention. Optical waveguide 60 comprises an optical fiber with a core 64 surrounded by a cladding 62. The core includes a host matrix and a plurality of nanoparticles dispersed within the host matrix. In one embodiment, core 64 comprises nanoparticles. The cladding material in this embodiment comprises a host matrix. In certain embodiments, the cladding material may also comprise nanoparticles dispersed in a host matrix. Further, in one embodiment of the present invention, the host matrix material of the core 64 and/or cladding layer 62 includes fluorine. The plurality of nanoparticles in the optical waveguide 60 may have an index of refraction ranging from about 1 to about 5. By selecting a particular material having a particular index of refraction value, the overall index of refraction of the core 64 of the optical waveguide 60 may be adjusted to a predetermined desired value or to different predetermined values.

In addition to the materials mentioned, still other materials are useful as nanoparticles 11. For example, the nanoparticles, themselves, may comprise a polymer. In an exemplary embodiment of the invention, the polymer nanoparticles comprise polymers that contain functional groups that can bind ions, such as rare-earth ions. Such polymers include homopolymers or copolymers of vinyl, acrylic, vinyl aromatic, vinyl esters, alpha beta unsaturated acid esters, unsaturated carboxylic acid esters, vinyl chloride, vinylidene chloride, and diene monomers. The reactive groups of these polymers may comprise any of the following: POOH, POSH, PSSH, OH, SO₃H, SO₃R, SO₄R, COOH, NH₂, NHR, NR₂, CONH₂, NH—NH₂, and others, where R may be chosen from linear or branched hydrocarbon-based chains, possibly forming at least one carbon-based ring, being saturated and unsaturated, aryl, alkyl, alkylene, siloxane, silane, ether, polyether, thioeter, silylene, and silazane.

The polymers for use as nanoparticles may alternatively comprise main chain polymers containing rare-earth ions in the polymer backbone, or side chain or cross-linked polymers containing the above-mentioned functional groups. Additionally, the nanoparticles may comprise organic dye molecules, ionic forms of these dye molecules, or polymers containing these dye molecules in the main chain or side chain, or cross-linked polymers. When the nanoparticles comprise polymers that are not halogenated, they may be optionally coated with a halogenated coating as described herein.

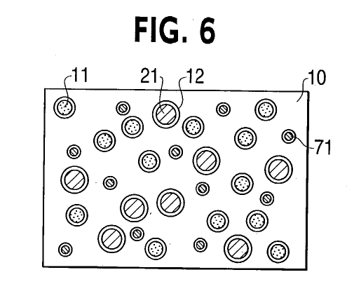

Composite materials comprising the amplifiers of the present invention may contain different types of nanoparticles. For example, FIG. 6 illustrates an exemplary embodiment of the present invention in which several groups of nanoparticles 11, 21, and 71 are present within halogenated matrix 10. Each group of nanoparticles 11, 21 and 71 is comprised of a different material surrounded by an outer layer (for example, layer 12 on particle 21).

Nanocomposites fabricated from several different nanoparticles may offer properties derived from the different nanoparticles. For example, nanoparticles 11, 21, and 71 may provide a range of different optical, structural, or other properties. Such an arrangement may be useful, for example to form broadband optical amplifiers and other optical devices according to the present invention. One skilled in the art will recognize that the present invention is not limited to a particular number of different types of nanoparticles dispersed within the host matrix material. Rather, any number of different types of nanoparticles may be useful in various applications. For example, nanocomposite Er or Er/Yb doped waveguide amplifier with waveguide core constructed of multiple types of nano-particles, may be made according to the present invention. In other embodiments, nanoparticles of Er doped alumino-germano-silicate glass, Er doped phosphate glass, and Er doped inorganic single crystal may be made according to the present invention. In certain embodiments, It is also possible to include multiple types of nanoparticles doped with multiple types of rare-earth ions such as Er, thulium, dysprosium, neodymium, etc into a single polymer waveguide core to achieve broader band amplification with each rare-earth ion species amplifying a sub-band within the amplifier gain bandwidth.

Depending on the end use, the nanoparticles according to the present invention may be bare, or contain at least one outer layer. As shown in FIG. 1, the nanoparticles may include an outer layer 12. The layer 12 may serve several important functions. It may be used to protect nanoparticle 11 from moisture or other potentially detrimental substances. Additionally, layer 12 may also prevent agglomeration. Agglomeration is a problem when making composite materials that include nanoparticles distributed within a matrix material.

In one embodiment, by selecting a layer 12 of a material that is compatible with a given host matrix material, layer 12 may eliminate the interfacial energy between the nanoparticle surfaces and host matrix 10. As a result, the nanoparticles in the composite material do not tend to agglomerate to minimize the interfacial surface area/surface energy that would exist between uncoated nanoparticles and host matrix material 10. Layer 12, therefore, enables dispersion of nanoparticles 11 into host matrix material 10 without agglomeration of the nanoparticles.

When the outer layer 12 is halogenated, it may comprise at least one halogen chosen from fluorine, chlorine, and bromine. In an exemplary embodiment of the present invention, the halogenated outer layer 12 may include, for example, halogenated polyphosphates, halogenated phosphates, halogenated phosphinates, halogenated thiophosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated disulfide, halogenated thiols, and halogenated alkylcyanide. While fluorine analogs of these materials can be used, analogs of these materials incorporating halogens other than fluorine, as well as hydrogen, may also be employed in outer layer 12.

In addition to protecting the nanoparticles 11 and suppressing agglomeration, layer 12 may also be designed to interact with the surfaces of nanoparticles 11. For example, halogenated outer layer 12 may comprise a material, such as one of the above listed layers, which reacts with and neutralizes an undesirable radical group, for example OH or esters, that may be found on the surfaces of nanoparticles 11. In this way, layer 12 may prevent the undesirable radical from reacting with host matrix 10. Coating 82 may also prevent fluorescence quenching in the case of fluorescence nanoparticles.

Coatings on nanoparticles 11 are not limited to a single layer, such as halogenated outer coating layer 12 shown in FIG. 1. Nanoparticles may be coated with a plurality of layers.

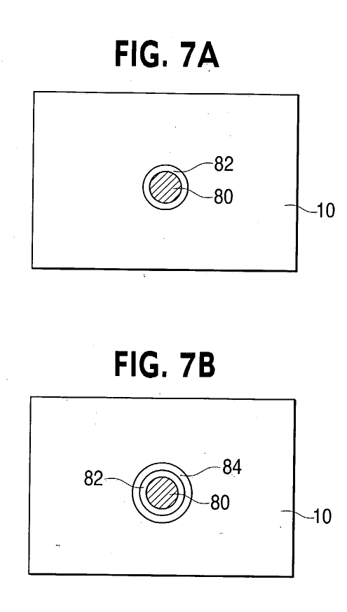

FIG. 7 schematically depicts one nanoparticle suspended within host matrix material 10. As shown, inner layer 84 is disposed between nanoparticle 80 and halogenated outer layer 82. In certain situations the interaction between a particular nanoparticle material 80 and a particular halogenated outer layer 84 may be unknown. In these situations, nanoparticles 80 may be coated with an inner coating layer 84 comprising a material that interacts with one or both of the nanoparticle material and the halogenated outer coating layer material in a known way to create a passivation layer. Such an inner coating layer may prevent, for example, delamination of the halogenated outer coating layer 82 from nanoparticle 80. While inner coating layer 84 is shown in FIG. 7 as a single layer, inner coating layer 84 may include multiple layers of similar or different materials.

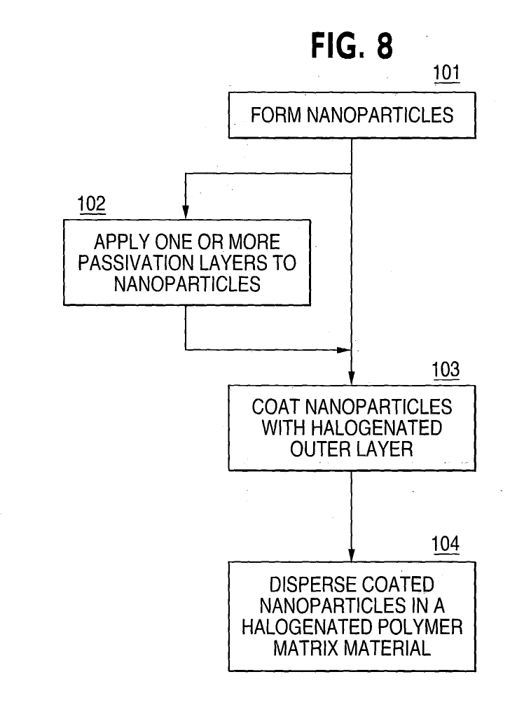

FIG. 8 is a flowchart diagram representing process steps for forming a composite material according to an exemplary embodiment of the present invention. Nanoparticles 11, as shown in FIG. 1 are formed during step 101. Once formed, nanoparticles 11 are coated with a halogenated outer layer 12 at step 103. Optionally, at step 102, an inner coating layer 84 (or passivation layer), as shown in FIG. 7, may be formed on the nanoparticles 80. Inner coating layer 84, which may include one or more passivation layers, may be formed prior to formation of halogenated outer layer 82 using methods similar to those for forming halogenated outer layer 82.

Nanoparticles may be coated in several ways. For example, nanoparticles may be coated in situ, or, in other words, during the formation process. The nanoparticles may be formed (for example by electro-spray) in the presence of a halogentated coating material. In this way, once nanoparticles 11 have dried to form an aerosol, they may already include layer 12 of the desired halogenated material.

In one embodiment, layer 12 may be formed by placing the nanoparticles into direct contact with the coating material. For example, nanoparticles may be dispersed into a solution including a halogenated coating material. In some embodiments, nanoparticles may include a residual coating left over from the formation process. In these instances, nanoparticles may be placed into a solvent including constituents for forming the halogenated outer layer. Once in the solvent, a chemical replacement reaction may be performed to substitute halogenated outer layer 12 for the preexisting coating on the plurality of nanoparticles 11. In one embodiment, nanoparticles may be coated with a coating in a gas phase reaction, for example, in a gas phase reaction of hexamethyidisilizane.

In another embodiment, the nanoparticles may be dispersed by co-dissolving them, and the host matrix, in a solvent (forming a solution), spin coating the solution onto a substrate, and evaporating the solvent from the solution.

In another embodiment, the nanoparticles may be dispersed in a monomer matrix, which is polymerized after the dispersion.

In yet another embodiment, coatings may be in the form of a halogenated monomer. Once the monomers are absorbed on the surface of the particles, they can be polymerized or cross-linked. Additionally, coatings in the form of polymers can be made by subjecting the particles, under plasma, in the presence of halogenated monomers, to form coated nanoparticles with plasma induced polymerization of the particle surface. The coating techniques described are not intended to be an exhaustive list. Indeed, other coating techniques known to one of ordinary skill in the art may be used.

Once nanoparticles have been formed and optionally coated, they are dispersed into host matrix at step 104, to obtain a uniform distribution of nanoparticles within host matrix, a high shear mixer or a sonicator may be used. Such high shear mixers may include, for example, a homogenizer or a jet mixer.

Another method of dispersing nanoparticles throughout the host matrix is to co-dissolve the nanoparticles with a polymer in a suitable solvent, spin-coating the solution onto a substrate, and then evaporating the solvent to form a polymer nanocomposite film.

Yet another method of dispersing nanoparticles throughout the host matrix is to disperse nanoparticles into a monomer, and then polymerize the monomer to form a nanocomposite. The monomer can be from the group comprising halogenated methacrylate, halogenated acrylate, halogenated styrene, halogenated substituted styrene, trifluorovinyl ether monomer, epoxy monomer with a cross-linking agent, and anhydride/diamine, although those skilled in the art will recognize that other monomers can be used as well. The dispersion techniques described are not intended to be an exhaustive list. Indeed, other dispersion techniques known to one of ordinary skill in the art can be used.

In another embodiment according to the present invention, the polymer nanocomposites comprising a host matrix and nanoparticles of various functionalities may offer improvement in gain medium: Due to the low optical loss, the polymer nanocomposites based on a fluoropolymer host matrix may offer a superior gain medium when doped with active nanoparticles comprising at least one material chosen from rare-earth elements, transition metal elements, and group II-VI ions.

In another embodiment of the amplifiers according to the present invention, the polymer nanocomposites comprising a host matrix and nanoparticles of various functionalities may further offer improvement in electro-optic properties, when the host matrix materials are doped with particles that exhibit electro-optic properties. The resulting nanocomposite offers the advantage of low optical loss, good film forming properties, low water absorptivity, thermal stability, and low term chemical resistance. Examples of suitable dopants include lithium niobate, GaAs, non-linear optical chromophores and organic dyes (derivatives of dithiophene, diphenoquinoid, anthraquinodimethane, etc.).

The present invention further comprises a method for making an optical waveguide amplifier comprising: a composite material comprising, a host matrix, a plurality of nanoparticles; doping said nanoparticles with at least one material chosen from Er and Yb; selecting the nanoparticles for amplification ranging from about 1.5 μm to about 1.6 μm, further from about 1.5 μm to about 1.6 μm, and yet further from about 1.57 μm to about 1.61 μm, and further about 1.55 μm; and adding the plurality of nanoparticles to the host matrix.

An optical fiber is one type of waveguide that can be used consistent with this invention. Another type of waveguide that can be used consistent with this invention is a planar waveguide. A planar waveguide core can have a cross-section that is, for example, substantially square, or any other shape that is conveniently fabricated. When a pump laser beam passes through the waveguide, external energy can be applied (e.g., at IR wavelengths), thereby pumping, or exciting, the excitable atoms in the gain medium and increasing the intensity of the signal beam passing there through. A signal beam emerging from the amplifier can retain most its original characteristics, but is more intense than the input beam.

Many types of optical amplifiers can be made consistent with this invention, including narrow-band optical amplifiers, such as 1.5 μm optical amplifiers, and ultra-broadband amplifiers.

An ultra-broadband optical amplifier consistent with this invention can span more than about 60 nanometers. In one embodiment, such an amplifier can span more than about 400 nanometers, far more than the bandwidth of amplifiers used in conventional commercial wavelength-division multiplexed communications systems, which normally only span about 30 to 60 nanometers. An optical network that uses an ultra-broadband amplifier consistent with this invention can handle, for example, hundreds of different wavelength channels, instead of the 16 or so channels in conventional networks, thereby greatly increasing capacity and enhancing optical-layer networking capability.

Rare-earth waveguide amplifiers operate on the basic 3-level and 4-level laser transition principles. The single pass gain of the waveguide amplifier is the fundamental parameter to be calculated. Amplification in a rare-earth-containing host matrix waveguide according to the present invention can be described with a 3-level model.

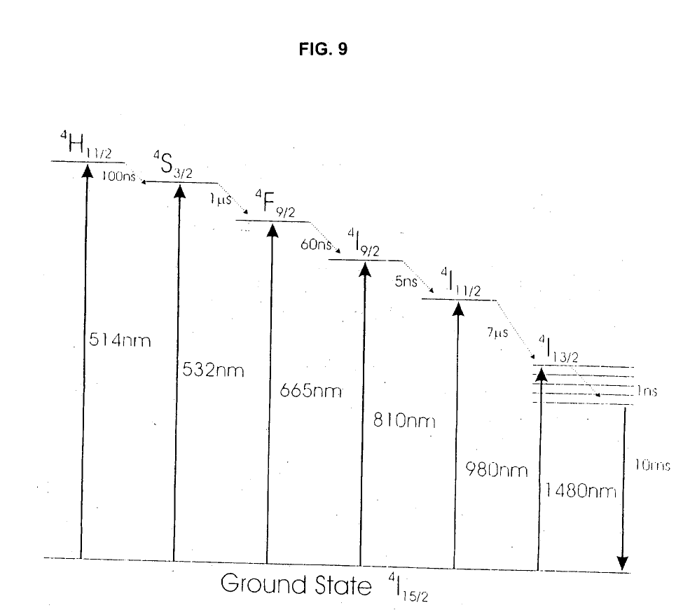

FIG. 9 is a schematic illustration of the energy level diagram of an Er ion. The various glasses, crystals, liquid crystals, solvents, or polymer host matrices according to the present invention, are doped with at least one Er containing material, optionally containing Yb.

The simple three-state model may describe the three and four state amplifiers according to the present invention. The rare-earth ions start out in their ground state. The electrons are then excited by a pump beam of photons with energy hνₚ (h is planks constant and νₚ is the frequency of the photon) equal to the equal to the transition energy from the ground state, level one, to an excited state, level two. The ions subsequently undergo fast nonradiative decay to another excited state, level three, which is the metastable state of the system. The lifetime of this state is very long in comparison to the nonradiative decay. As a consequence, a population inversion is created in level three. Then, as a signal beam passes by the ions, it stimulates emission of photons with the same signal energy, hνₛ. This stimulated decay is from level three to level one, the ground state.

The pump photons enter the Er or Yb doped fiber or waveguide core are absorbed by the ground state Er or Yb ions. The absorption of the pump photons causes the excitation of the ions into their excited energy state. The excited state ions rapidly (in less than about 10 μsec) relax to the metastable excited state. The metastable excited state has a relatively long lifetime when not triggered (greater than about 1 msec). When triggered by a signal photon with wavelength around 1.5 μm, a metastable state ion drops back to its ground state and releases a emission photon identical to the triggering signal photon, thereby amplifying the signal.

For example, light amplification from Er doped materials results when a photon with wavelength of about 0.98 μm is exiting from the ground-state ⁴I_{15/2} ion to an excited state. The excited ion subsequently undergoes fast nonradiative decay to ^{4I}_{13/2}. The ion relaxing from the ⁴I_{13/2} level to the ^{4I}_{15/2} level, gives its energy up as a photon. The photon interacts with an electron in an excited energy level resulting in the formation of an additional photon with same wavelength and phase.

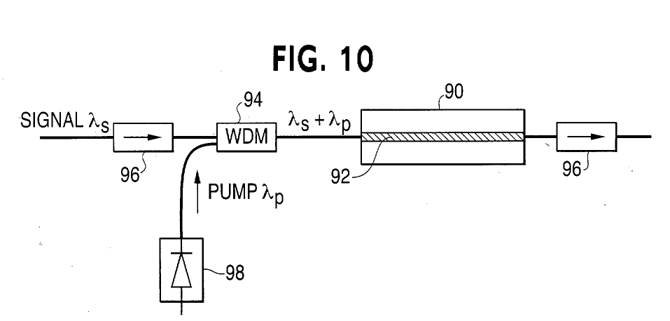

FIG. 10 is a schematic illustration of the configuration of a 1.5 μm waveguide amplifier comprising isolators 96, wavelength division multiplexer 94 (WDM), and doped nanocomposite channel waveguide 90. The signal λ_{S} is coupled with pump signal λ_{P} (λ_{P} generated by pump source 98) through WDM 94 and injected into the amplification waveguide channel 92. Optical signals isolators 96 are placed at the input and the output end of the waveguide amplifier to prevent back reflected signal light.

The pump wavelengths for the Er doped nano-composite waveguide amplifier include 0.98 μm, 1.48 μm.

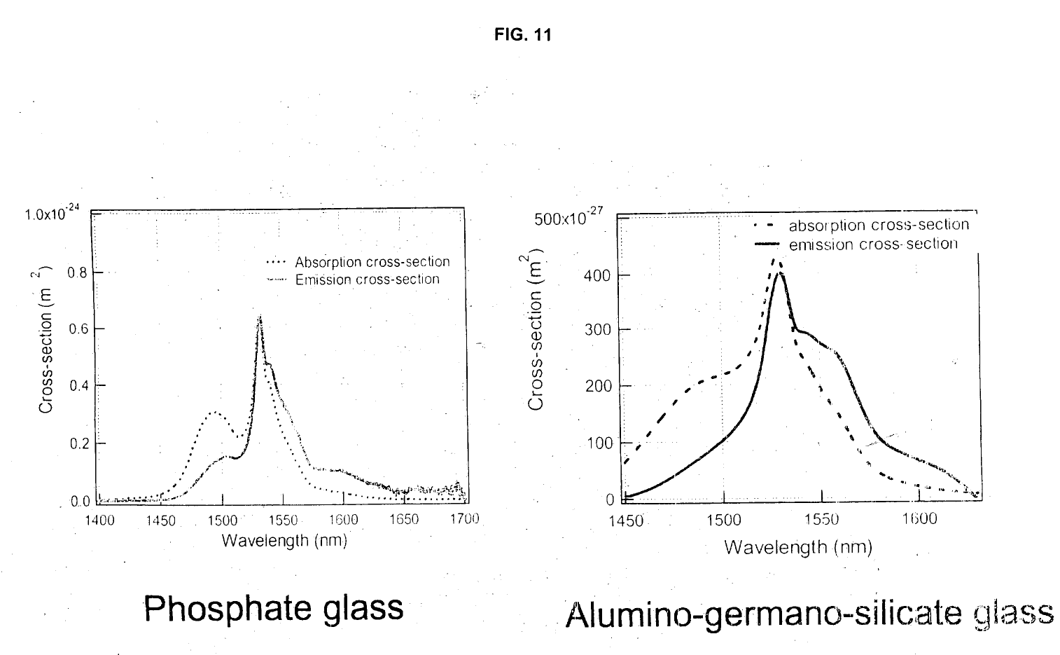

FIG. 11 shows the emission and absorption cross-section spectra of Er doped phosphate glass and alumino-germano-silicate glasses. The emission peak wavelength in both glasses is around 1532 nm. The emission spectra cover a range from less than 1500 nm to higher than 1620 nm, indicating the feasibility of amplification within this range.

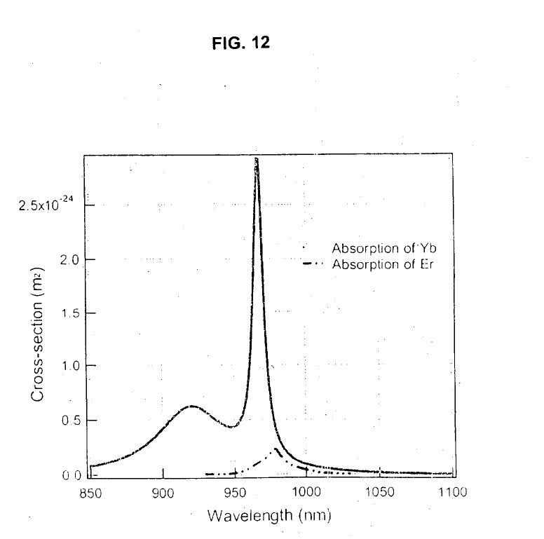

FIG. 12 shows the absorption cross-section of Yb as compared with the absorption cross-section of Er. The absorption cross-section of Yb is about an order of magnitude higher than that of Er, providing the ability of Yb to serve as an absorption sensitizer in a Yb and Er co-doped system. Further, the absorption spectrum of Yb covers a broader range than that of Er, enabling the usability of a wider range of pump wavelengths in a Yb and Er co-doped systems than an Er doped system.

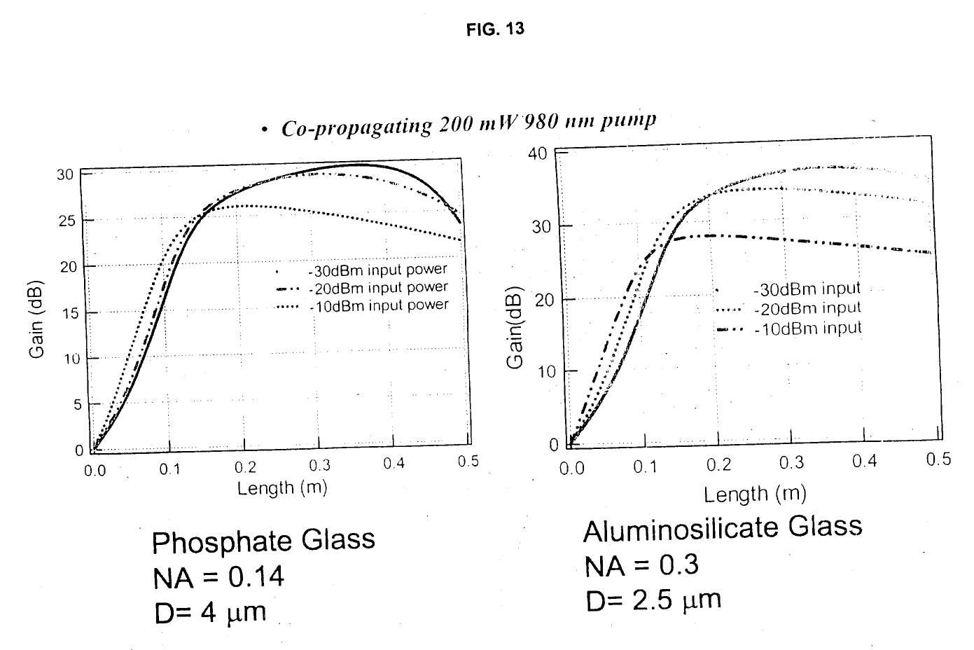

FIG. 13 shows 1550 nm single channel small signal gain evolution in a polymer nanocomposite Er doped waveguide with particles composed of Er doped phosphate glass or alumino-germano-silicate glass with parameters listed in Table 1. The data indicates the feasibility of such polymer nanocomposite optical waveguide amplifiers of 5-50 centimeters long with enough signal gain

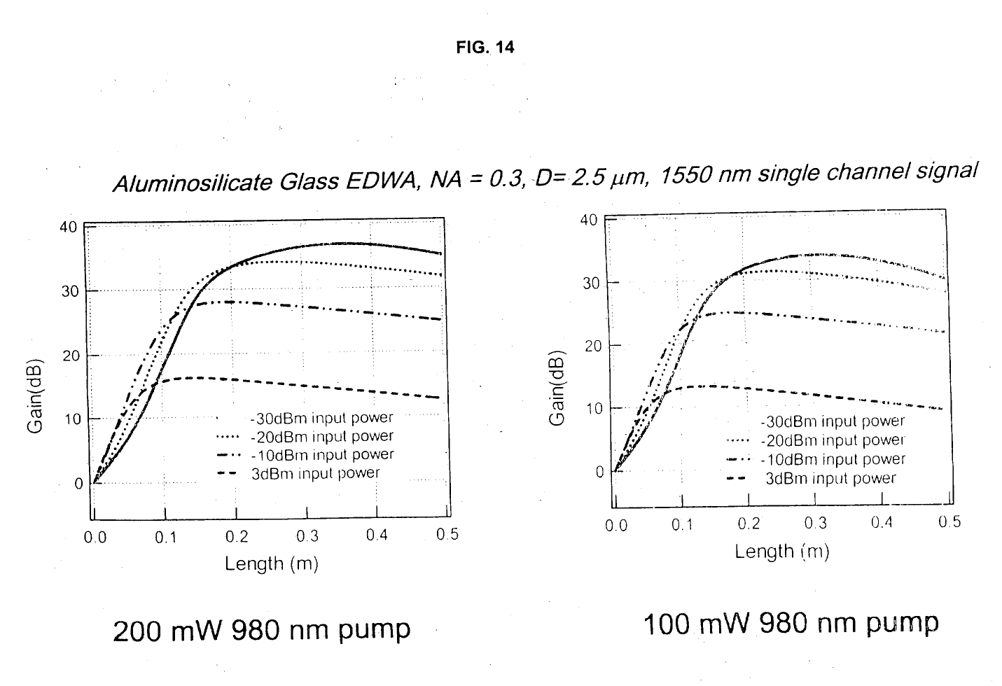

FIG. 14 shows the gain dependence on input signal power levels for an Er doped alumino-germano-silicate glass/polymer nanocomposite waveguide amplifier. The parameters for this waveguide amplifier are listed in Table 1. As shown in FIG. 14, the waveguide length for maximum signal gain decreases as the input signal power increases, reflecting the saturation behavior of the amplifier. As a comparison between 200 mW and 100 mW pump power, the simulation indicates that the increased pump power enhances the signal gain about 3 dB at all signal input levels. This 3 dB gain increase corresponds to a significant increase (50%) for the saturated output power of the amplifier. However, it corresponds to less than 10% of the small signal gain figure, and is not a significant factor for small signal gain. This is due to the effect of the amplified spontaneous emission (ASE), which is mostly backward propagating ASE. The backward ASE consumes most of the pump energy when the amplifier is operating under high pump power with small input signal power. To achieve amplifier small signal gain significantly beyond 40 dB, multiple stage amplifiers are required to block the backward ASE and fully utilize the high pump power.

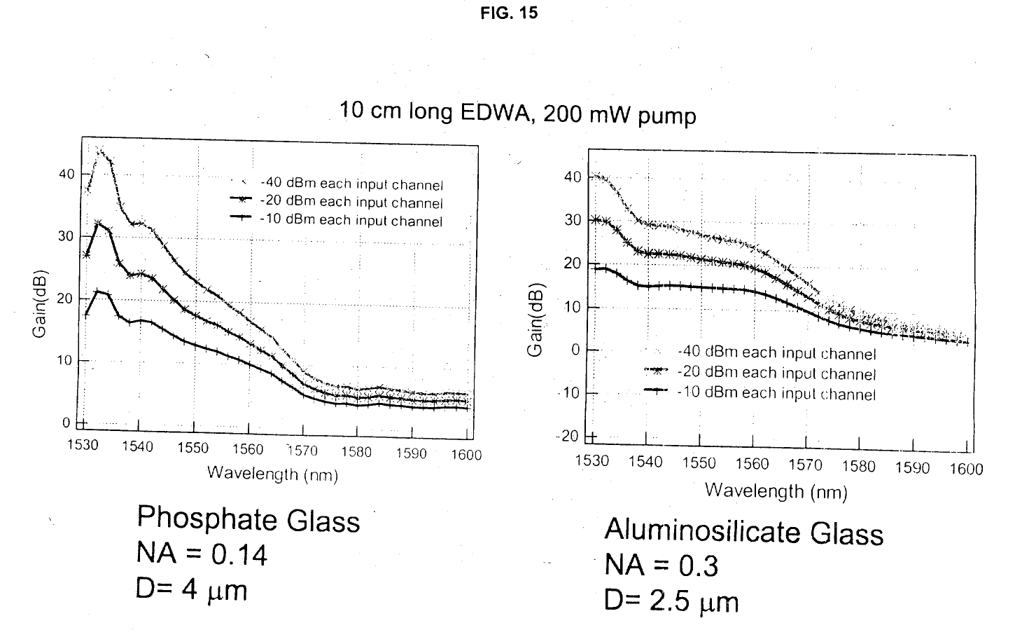

FIG. 15 shows the gain spectra of a 10 centimeter long phosphate glass and alumino-germano-silicate glass nano-composite waveguide amplifier.

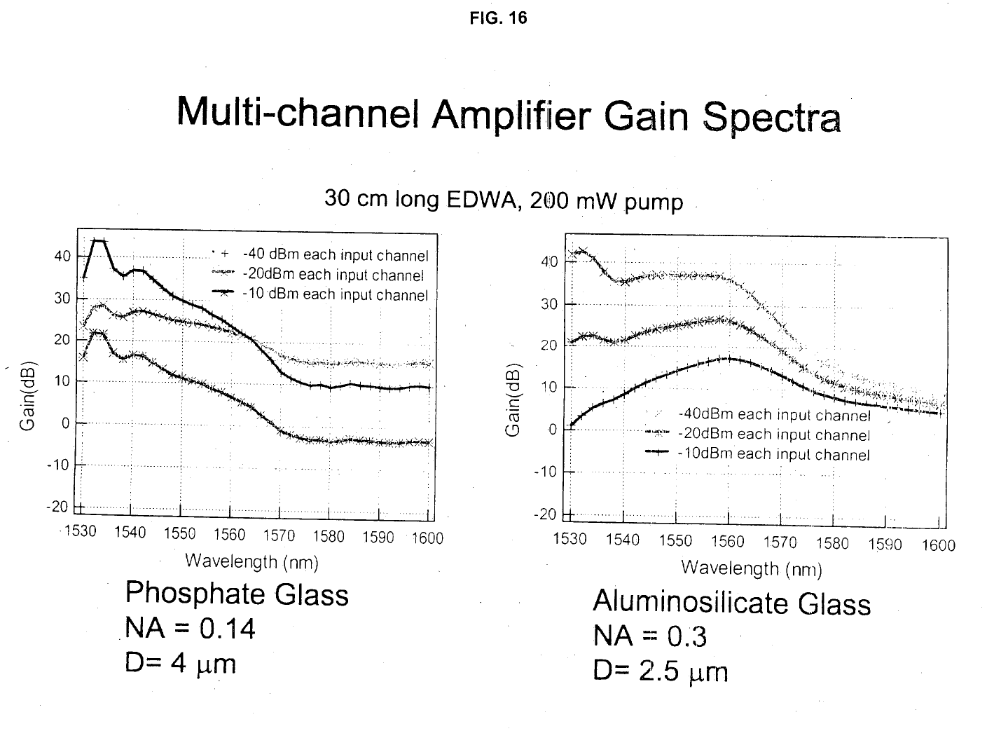

FIG. 16 shows the gain spectra of a 30 centimeter long phosphate glass and alumino-germano-silicate glass nano-composite waveguide amplifier

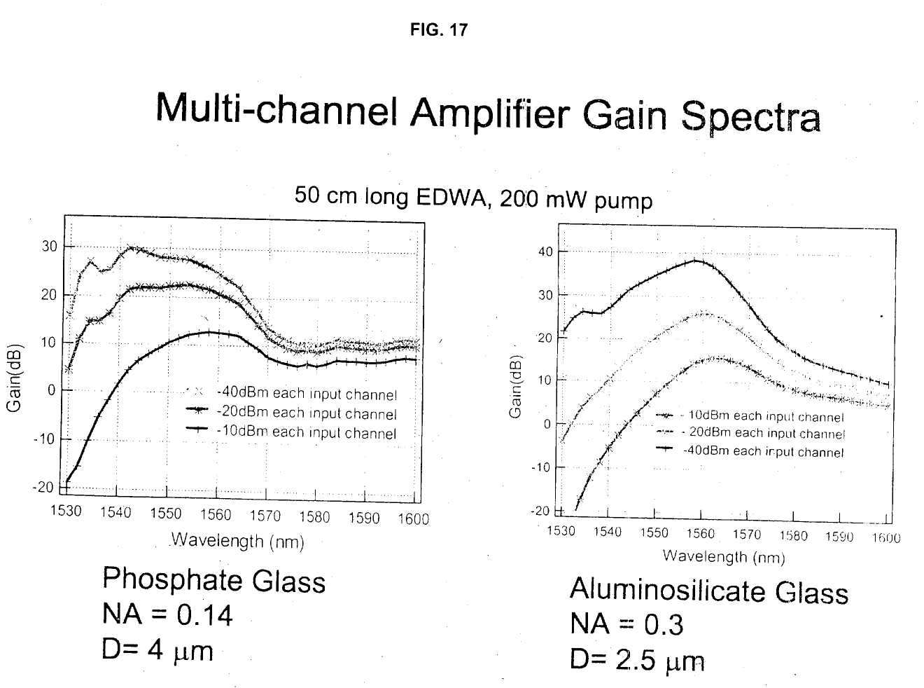

FIG. 17 shows the gain spectra of a 50 centimeter long phosphate glass and alumino-germano-silicate glass nano-composite waveguide amplifier It is important to find out the waveguide amplifier gain spectrum with multiple input signal channels, as dense wavelength division multiplexed (DWDM) systems are increasingly being used in modern optical networks. We calculated the EDWA gain spectra in the C and L band region within the 1.5 μm telecommunication window with 2 nm spacing channels launched simultaneously into the amplifier. FIGS. 15-17 shows the amplifier gain spectra under various input signal power level conditions

A critical property of optical amplifier is the gain flatness. For applications in DWDM systems, amplifiers need to be designed so that the gain is equal across the entire amplifier operating wavelength span. A gain variation smaller than 1 dB is the typical requirement. To achieve this, various types of external gain flattening filters are usually used in combination with the internal gain shape of the amplifier It is shown in FIGS. 15-17 that the gain spectra vary with different signal input power conditions. FIGS. 15-17 also indicate that the gain peak shifts from around 1530 nm to 1540-1560 nm when the length of the waveguide increases. This is due to the fact that the emission cross-section spectrum of Er at around 1550 nm overlaps with its absorption cross-section spectrum with a “red shift”. As the signal channels and the ASE propagate along the Er doped waveguide, there is a equilibrium of the absorption an emission processes.

In certain embodiments, co-doping with Yb increases the fluorescence emitted by the rare-earth ions. Because of the near-resonant energy levels of the co-dopants, co-doping result in more efficient process. For example, the ⁴I_{11/2} level of Er ion is nearly resonant in energy to the ²F_{5/2} level of Yb ion. Due to Yb's high absorption cross-section, it can absorb the pump radiation for 0.98 μm efficiently, and can transfer this absorbed energy to Er ion. Consequently, co-doping result in a more power efficient process than direct excitation of a single dopant in many materials.

In one embodiment, the perfluorinated polymer waveguide cores are filled with nanometer size particles of various glasses, polymers, and crystal materials. In a further embodiment, the nanometer size particles are doped with Er, or co-doped with Er and/or Yb for light amplification ranging from about 1.5 μm to longer wavelengths, further from about 1.5 μm to about 1.6 μm, and yet further from about 1.57 μm to about 1.61 μm, and further about 1.55 μm.

TABLE 1
EDWA parameters for a Multi Channel nanocomposite Er doped
amplifier gain spectra: 30 cm long EDWA, 200 mW pump

| | Parameter | Value |
|---|---|---|
| Aluminosilicate Glass | Er-doped core width and height | 2.5 μm |
| Nano-composite | Waveguide Type | Buried Channel |
| | | waveguide |
| waveguide | Numerical aperture | 0.30 |
| | of waveguide | |
| | Er ion density | 3.6 × 10²⁶ m⁻³ |
| | Er metastable state lifetime | 10 msec |
| | Waveguide loss | 0.1 dB/cm |
| | Pump wavelength | 0.98 μm |
| | Pump direction | Co-propagation |
| | | pump |
| Phosphate Glass | Er-doped core width and height | 4 μm |
| Nano-composite | Waveguide Type | Buried Channel |
| | | waveguide |
| waveguide | Numerical aperture | 0.14 |
| | of waveguide | |
| | Er ion density | 3.6 × 10²⁶ m⁻³ |
| | Er metastable state lifetime | 8 msec |
| | Waveguide loss | 0.1 dB/cm |
| | Pump wavelength | 0.98 μm |
| | Pump direction | Co-propagation |
| | | pump |

Table 1 provides examples of two Er doped nano-composite waveguide amplifiers. The key material and waveguide design parameters are listed in the table. The full emission and absorption cross-section spectra of these two waveguide amplifiers are shown in FIGS. 11 and 12. Base on these parameters, numerical simulations are carried out for the gain performance. The results for these two amplifiers are illustrated in FIGS. 13-17.

FIGS. 15, 16, and 17 show the amplifier gain spectra under various input signal power level conditions. The pump powers are all 200 mW at 0.98 μm.

A critical property of an optical amplifier is the gain flatness wherein amplifiers need to be designed so that the gain is equal across the entire amplifier operating wavelength span. A gain variation smaller than 1 dB is the typical requirement to achieve this, various types of external gain flattening filters are usually used in combination with the internal gain shape of the amplifier. As illustrated in FIGS. 15, 16, and 17, the alumino-germano-silicate glass nano-composite waveguide amplifier gain spectra vary with different signal input power conditions and that the gain peak shifts from about 1.5 μm to about 1.6 μm when the length of the waveguide increases. FIGS. 15, 16, and 17 also show the amplifier gain spectra of phosphate glass nanocomposite waveguide amplifier at various input signal level conditions. The gain spectra vary significantly with different input signal power levels and waveguide lengths. The gain flatness improves with longer waveguide amplifier length. Further, the simulation results indicate that there is a relatively flat gain region ranging from about 1.57 μm to about 1.60 μm with moderate gain raging from about 10 dB to about 15 dB.

What is claimed is:

1. An optical waveguide amplifier comprising:
a polymer composite material comprising,
a polymer host matrix,
a plurality of nanoparticles within the host matrix;
said plurality of nanoparticles comprising at least one Er containing material.

2. The amplifier of claim 1, wherein said at least one Er containing material is an ion, compound, polymer, or complex of Er ion, or Er doped semiconductor, or insulator.

3. The amplifier of claim 1, wherein said composite material further comprises at least one Yb containing material.

4. The amplifier of claim 1, wherein said plurality of nanoparticles is capable of producing stimulated emissions of light at a wavelength of at least about 1.5 μm when pumped.

5. The amplifier of claim 4, wherein said plurality of nanoparticles is capable of producing stimulated emissions of light at a wavelength ranging from about 1.5 μm to about 1.6 μm, when pumped.

6. The amplifier of claim 5, wherein said plurality of nanoparticles is capable of producing stimulated emissions of light at a wavelength ranging from about 1.57 μm to about 1.61 μm, when pumped.

7. The amplifier of claim 6, wherein said plurality of nanoparticles is capable of producing stimulated emissions of light at a wavelength about 1.55 μm, when pumped.

8. The amplifier of claim 1 wherein said polymer host matrix is a halogen containing polymer.

9. The amplifier of claim 1, wherein said polymer host matrix comprises a polymer, a copolymer, a terpolymer, or a polymer blend having at least one halogenated monomer chosen from one of the following formulas: 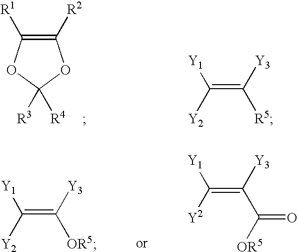
wherein,
R¹, R², R³, R⁴, and R⁵, which may be identical or different, are each chosen from linear or branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

10. The amplifier claim 9, wherein R¹, R², R³, R⁴, and R⁵ are at least partially fluorinated.

11. The amplifier of claim 9, wherein R¹, R², R³, R⁴, and R⁵ are completely fluorinated.

12. The amplifier of claim 9, wherein at least one of R¹, R², R³, R⁴, and R⁵ is chosen from C₁-C₁₀, linear or branched, saturated or unsaturated hydrocarbon-based chains.

13. The amplifier of claim 9, wherein said host matrix comprises a polymer condensation product of at least one of the following monomeric reactions:
HO—R—OH+NCO—R′—NCO; or
HO—R—OH+Ary¹-Ary²,
wherein
R, R′, which may be identical or different, are chosen from one of halogenated alkylenes, halogenated siloxanes, halogenated ethers, halogenated silylenes, halogenated arylenes, halogenated polyethers, and halogenated cyclic alkylenes; and
Ary¹, Ary², which may be identical or different, are chosen from halogenated aryls and halogenated alkyl aryls.

14. The amplifier of claim 9, wherein said host matrix comprises a material chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

15. The amplifier of claim 9, wherein said host matrix comprises a combination of two or more different fluoropolymer materials.

16. The amplifier of claim 9, wherein said host matrix further comprises halogenated polymers having functional groups chosen from phosphinates, phosphates, carboxylates, silanes, siloxanes, and sulfides.

17. The amplifier of claim 1, wherein said material comprises functional groups chosen from POOH, POSH, PSSH, OH, SO₃H, SO₃R, SO₄R, COOH, NH₂, NHR, NR₂, CONH₂, and NH—NH₂, wherein R denotes: linear or branched hydrocarbon-based chains, capable of forming at least one carbon-based ring, being saturated or unsaturated; alkylenes, siloxanes, silanes, ethers, polyethers, thioethers, silylenes, and silazanes.

18. The amplifier of claim 1, wherein at least one material comprising said host matrix is chosen from homopolymers, or copolymers, of vinyl, acrylate, methacrylate, vinyl aromatic, vinyl ester, alpha beta unsaturated acid ester, unsaturated carboxylic acid ester, vinyl chloride, vinylidene chloride, and diene monomers.

19. The amplifier of claim 9, wherein said host matrix comprises a hydrogen-containing fluoroelastomer.

20. The amplifier of claim 9, wherein said host matrix further comprises a cross-linked halogenated polymer.

21. The amplifier of claim 20, wherein said halogenated polymer comprises a fluorinated polymer.

22. The amplifier of claim 9, wherein said host matrix comprises a perhalogenated polymer.

23. The amplifier of claim 22, wherein the perhalogenated polymer comprises a perfluorinated polymer.

24. The amplifier of claim 9, wherein said host matrix comprises a perhalogenated elastomer.

25. The amplifier of claim 9, wherein said host matrix comprises a perfluoroelastomer.

26. The amplifier of claim 9, wherein said host matrix comprises a fluorinated plastic.

27. The amplifier of claim 9, wherein said host matrix comprises a perfluorinated plastic.

28. The amplifier of claim 9, wherein said host matrix comprises a blend of halogenated polymers.

29. The amplifier of claim 9, wherein said host matrix comprises a blend of fluorinated polymers.

30. The amplifier of claim 9, wherein said host matrix comprises a blend of perfluorinated polymers.

31. The amplifier of claim 9, wherein said host matrix comprises poly[2,2-bistrifluoromethyl-4,5-difluoro-1,3-dioxole-co-tetrafluoroethylene].

32. The amplifier of claim 9, wherein said host matrix comprises poly[2,2-bisperfluoroalkyl-4,5-difluoro-1,3-dioxole-co-tetrafluoroethylene].

33. The amplifier of claim 9, wherein said host matrix comprises poly[2,3-(perfluoroalkenyl) perfluorotetrahydrofuran].

34. The amplifier of claim 9, wherein said host matrix comprises poly[2,2,4-trifl uoro-5-trifluoromethoxy-1,3-dioxole-co-tetrafluoroethylene].

35. The amplifier of claim 9, wherein said host matrix comprises poly(pentafluorostyrene).

36. The amplifier of claim 9, wherein said host matrix comprises fluorinated polyimide.

37. The amplifier of claim 9, wherein said host matrix comprises fluorinated polymethylmethacrylate.

38. The amplifier of claim 9, wherein said host matrix comprises polyfluoroacrylates.

39. The amplifier of claim 9, wherein said host matrix comprises polyfluorostyrene.

40. The amplifier of claim 9, wherein said host matrix comprises fluorinated polycarbonates.

41. The amplifier of claim 9, wherein said host matrix comprises perfluoro-polycyclic polymers.

42. The amplifier of claim 9, wherein said host matrix comprises fluorinated cyclic olefin polymers.

43. The amplifier of claim 9, wherein said host matrix comprises fluorinated copolymers of cyclic olefins.

44. The amplifier of claim 1, wherein said plurality of nanoparticles further comprises at least one ion, oxide, compound, polymer, or complex, of an element chosen from rare-earth metals, transition metals, groups III, IV or V elements, V²⁺, V³⁺, Cr³⁺, Cr⁴⁺, Co²⁺, Fe²⁺, Ni²⁺, Ti³⁺, and Bi³⁺.

45. The amplifier of claim 44, wherein said element is combined with at least one material chosen from oxides, phosphates, halophosphates, arsenates, sulfates, borates, aluminates, gallates, silicates, germanates, vanadates, niobates, tantalates, tungstates, molybdates, alkalihalogenates, halides, nitrides, nitrates, sulfides, zirconates, selenides, sulfoselenides, oxysulfides, phosphinates, hexafluorophosphinates, and tetrafluoroborates.

46. The amplifier of claim 44, wherein said at least one compound is a semiconductor compound.

47. The amplifier of claim 44, wherein said at least one compound is an insulator compound.

48. The amplifier of claim 46, wherein said semiconductor compound is chosen from Si, PbS, Ge, GaP, GaAs, InP, InAs, InSb, PbSe, and PbTe.

49. The amplifier of claim 48, wherein said semiconductor compounds are doped.

50. The amplifier of claim 1, wherein said plurality of nanoparticles comprises at least one material having an index of refraction ranging from about 1 to about 5.

51. The amplifier of claim 45, wherein said plurality of nanoparticles further comprises at least one material chosen from lithium niobate, non-linear optical chromophores, and organic dyes.

52. The amplifier of claim 1, wherein said plurality of nanoparticles further comprises at least one material chosen from dye materials.

53. The amplifier of claim 1, wherein said plurality of nanoparticles further comprises at least one functional group chosen from POOH, POSH, PSSH, OH, SO₃H, SO₃R, SO₄R, COOH, NH₂, NHR, NR₂, CONH₂, and NH—NH₂, wherein R is chosen from linear or branched hydrocarbon-based chains, capable of forming at least one carbon-based ring, being saturated or unsaturated, alkylenes, siloxanes, silanes, ethers, polyethers, thioethers, silylenes, and silazanes.

54. The amplifier of claim 1, wherein said plurality of nanoparticles comprises at least one polymer nanocomposite.

55. The amplifier of claim 54, wherein said at least one polymer nanocomposite comprises homopolymers, copolymers, terpolymers, or blends

56. The amplifier of claim 1, wherein a majority of said plurality of nanoparticles having a shortest dimension of less than about 50 nm.

57. The amplifier of claim 1, wherein a majority of said nanoparticles are coated.

58. The amplifier of claim 57, wherein said nanoparticles include a halogenated outer coating layer.

59. The amplifier of claim 58, wherein the halogenated outer coating layer is formed from at least one material chosen from polyphosphates, phosphates, phosphinates, dithiophosphinates, pyrophosphates, alkyl titanates, alkyl zirconates, silanes, alcohols, amines, carboxylates, amides, sulfates, esters, acid chloride, acetylacetonate, thiols, and alkylcyanide.

60. The amplifier of claim 58, wherein the halogenated outer coating layer is fluorinated.

61. The amplifier of claim 57, wherein said plurality of nanoparticles further includes an inner coating disposed beneath the halogenated outer coating layer, wherein the inner coating includes one or more passivation layers.

62. The amplifier of claim 61, wherein the halogenated outer coating layer comprises a material that reacts with and neutralizes a radical group on at least one of the plurality of nanoparticles.

63. The amplifier of claim 62, wherein the radical group is OH.

64. The amplifier of claim 62, wherein the radical group comprises an ester.

65. An optical waveguide amplifier comprising:
a composite material comprising;
a halogen containing host matrix; and
a plurality of nanoparticles within the host matrix,
wherein said plurality of nanoparticles comprise at least one dopant material that provides amplification ranging from about 1.5 μm to longer wavelengths.

66. The amplifier of claim 65, wherein said dopant material is capable of producing stimulated emissions of light at a wavelength ranging from about 1.5 μm to longer wavelengths.

67. The amplifier of claim 66, wherein said dopant material is capable of producing stimulated emissions of light at a wavelength ranging from about 1.57 μm to about 1.61 μm.

68. The amplifier of claim 67, wherein said dopant material is capable of producing stimulated emissions of light at a wavelength about 1.55 μm.

69. The amplifier of claim 65, wherein said at least one dopant material is chosen from Er and Yb.

70. The amplifier of claim 69, wherein at least one said dopant material is Er.

71. The amplifier of claim 69, wherein at least one said dopant material is Yb.

72. The optical waveguide of claim 65, wherein said dopant material is capable of producing stimulated emissions of light at a wavelength about 1.55 μm when pumped, said waveguide having input and output end.

73. An optical amplifying waveguide including a core, said core comprising:
a composite material comprising,
a host matrix; and
a plurality of nanoparticles dispersed within the host matrix, wherein
a majority of the plurality of nanoparticles include a halogenated
outer coating layer,
wherein said nanoparticles comprise at least one Er dopant material, and
a core-cladding comprised of a lower refractive index material, such that a core-cladding refractive index difference is small enough to result in a single optical mode propagation for optical wavelengths ranging from 1.5 μm to longer wavelengths.

74. An apparatus for optical communication including:
an active material comprising,
a halogen containing host matrix, and
a plurality of nanoparticles within the host matrix, wherein said
plurality of nanoparticles comprise at least one material chosen
from Er and Yb,
said apparatus further including a device for generating an optical signal and an optical pumping,
and providing said optical signal and said optical pumping to an optical waveguide.

75. The apparatus according to claim 74, wherein said apparatus is an optical amplification system for use in the near infrared region.

76. An optical amplifier for wavelength ranging from about 1.5 μm to longer wavelengths comprising:
nanoparticle composite material comprising:
a host matrix
a plurality of nanoparticles dispersed within the host matrix, wherein a majority of nanoparticles comprises Er and/or Yb and includes a halogenated outer coating layer.

77. A method for amplifying a light signal, said method comprising:
forming a component from a composite material comprising, a halogen containing host matrix, and a plurality of nanoparticles within the host matrix;
doping said host matrix with nanoparticles comprising at least one material chosen from Er and Yb;
exciting ions of said at least one material into their excited energy state; and
emitting a photon substantially identical to the triggering signal photon.

78. The method of claim 77, wherein said at least one material is capable of producing stimulated emissions of light at a wavelength ranging from about 1.5 μm to longer wavelengths.

79. The method of claim 77, wherein said at least one material is capable of producing stimulated emissions of light at a wavelength ranging from about 1.57 μm to longer wavelengths.

80. The method of claim 77, wherein said at least one material is capable of producing stimulated emissions of light at a wavelength about 1.55 μm.

81. A method for amplifying a light signal, said method comprising:
forming a component from a composite material comprising, a halogen containing host matrix, and a plurality of nanoparticles within the halogen containing host matrix; and
doping said halogen containing host matrix with nanoparticles comprising at least one material chosen from materials capable of producing stimulated emissions of light within a wavelength ranging from about 1.5 μm to about 1.6 μm.

82. The method according to claim 81, wherein said component is an optical amplifier comprising a low phonon energy optical medium,
and a device for pumping the low phonon energy optical medium to obtain an amplified optical signal within said wavelength range of about 1.5 μm to about 1.6 μm.
